(19) United States
(12) Patent Application Publication
(10) Pub. No.: US 2012/0128444 A1
(43) Pub. Date: May 24, 2012

(54) Anchor Module for Mining and Tunneling

(76) Inventors: Richard Podesser, Buchloe (DE); Lothar Schwalbach, Scheuring (DE)

(21) Appl. No.: 13/294,753

(22) Filed: Nov. 11, 2011

(30) Foreign Application Priority Data
Nov. 11, 2010 (DE) 102010043769.7

(51) Int. Cl. F16B 13/06; E21B 10/00

(52) U.S. Cl. 411/50; 175/327

(57) ABSTRACT

An anchor module, in particular for mining and tunneling, is provided. The anchor module comprises a drill bit having a drill section and a connecting section. The anchor module also comprises an anchor rod made of plastic, extending along an anchor axis and having a connecting section for fastening the drill bit in the area of the one axial rod end, such that the outside diameter of the drill bit is larger than the outside diameter of the anchor rod on the connecting section, wherein the outside diameter of the drill bit is at most about 20%, in particular embodiments at most about 10%, and/or at most about 10 millimeters larger than the outside diameter of the anchor rod on the connecting section.

### RELATED APPLICATIONS

The present application claims priority to German Patent Application DE 10 2010 04.7 filed Nov. 11, 2010, and entitled “Ankerbaugruppe, Insbesondere fur den Berg- and Tunnelbau” (“Anchor Module, in Particular for Mining and Tunneling”), the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The invention relates to an anchor module, in particular for mining and tunneling, comprising a drill bit having a drill section and a connecting section, as well as an anchor rod made of plastic, extending along an anchor axis and having a connecting section in the area of its axial rod end for attaching the drill bit.

Anchor modules have long been known in general for rock face sealing, in particular for securing mine shaft walls in mining and tunnel walls in construction of highways and railways. Metallic anchor rods with a prefabricated thread are generally used. In addition, the anchor rod, the anchor module comprises at least one functional part for a lock nut, which is screwed onto the anchor rod in placement of the anchor.

To save on the cost of materials and weight, anchor modules consisting of an anchor rod made of plastic have recently come on the market, these plastic anchor rods often being designed with fiber reinforcement to improve their mechanical properties. Especially well-known examples here include so-called glass fiber reinforced plastic anchors, i.e., anchor modules having an anchor rod made of glass fiber reinforced plastic.

The anchor rods made of plastic have hardly any extensibility due to their high modulus of elasticity, and they have only a low compressive strength and shear strength. Due to the low extensibility, the anchors are placed relatively closely to prevent any movement of the substrate and to reduce the resulting shear forces per anchor. Due to the low compressive strength and shear strength, a substantial percentage of traditional glass fiber reinforced anchors are damaged or even destroyed by the compressive and shear forces occurring during installation. The known glass fiber reinforced anchor rods have a functional part, for example, a lock nut on their axial end or (in the case of self-tapping anchor modules) a drive nut with the help of which the anchor module is installed. These nuts may be made of steel or plastic and are screwed onto a thread prefabricated on the anchor rod. However, these screw connections are unable to absorb high torques or tensile forces.

The prefabricated thread, in particular on the anchor rod, can easily be damaged even before the manufacture of the anchor module, or in shipping, or in assembly of the plastic anchor, whereupon the anchor module can no longer be used. Moreover, the threaded connection between the anchor rod and the functional part can absorb only a small portion (usually only approx. 20-30%) of the maximum allowed tensile force of the anchor rod.

One advantage of glass fiber reinforced anchors is that they can absorb very high tensile forces and consequently are excellently suited for back-anchoring tunnel walls or mine shaft walls. In the case of a subsequent widening of a tunnel or mine shaft cross section, the low compressive strength and shear strength of the plastic anchor rods proves advantageous. Due to the their low shear strength, anchor rods for rock face sealing of the original tunnel or mine shaft that extend in the rock to be removed can be destroyed relatively easily by tunnel drilling machines or clearing and stripping machines while widening the cross section without damage to the machines themselves.

### BRIEF SUMMARY OF THE INVENTION

The object of aspects of the present invention is to provide a self-cutting anchor module, which can be positioned with the lowest possible mechanical stress on its anchor components which has a robust connection between its anchor rod made of plastic and the functional part, this connection being capable of absorbing high tensile forces and torques.

According to aspects of the present invention this object is achieved by an anchor module of the type defined in the introduction with which an outside diameter of the drill bit is at most about 20%, in particular embodiments at most about 10%, and/or at most about 10 millimeters larger than the outside diameter of the anchor rod on the connecting section. The drill bit diameter is especially preferably at most about 8 millimeters and, in particular embodiments at most about 6 millimeters, larger than the anchor rod diameter.

Because of these minor differences in diameter between the drill bit and the anchor rod, a borehole whose volume is only slightly larger than the volume claimed by the anchor rod is formed in setting the anchor. Accordingly only a small amount of filling material is necessary to establish a bond between the anchor module and the substrate surrounding the anchor module. By minimizing the size of the borehole, the drilling effort as well as the mechanical stress on the anchor module is reduced, in particular with regard to the torques to be transmitted in introduction and/or placement of the self-tapping anchor module.

To increase the torques transmissible in the introduction of the self-tapping module in general, a sleeve which surrounds the anchor rod in the area of its connecting section may be provided for an anchor module, such that the outside diameter of the drill bit is larger than the outside diameter of the sleeve. However, the outside diameter of drill bit is especially preferably at most about 6 millimeters and, in particular embodiments at most about 3 millimeters, larger than the outside diameter of the sleeve.

The sleeve is preferably attached to the anchor rod with a press fit. First, such a press fit offers a simple option from the standpoint of manufacturing technology for attaching the sleeve to the anchor rod permanently; secondly, a fit between the sleeve and the anchor rod that is at least largely without tolerance is helpful in order to achieve a reinforcement of the connection between the drill bit and the anchor rod through the sleeve. Alternatively, however, the sleeve may also be secured on the anchor rod in some other suitable manner.

The sleeve may have a wall thickness of a maximum of about 2 millimeters, in particular embodiments of a maximum of about 1 millimeter. With such a small wall thickness, usually a larger drill bit need not be used when using the sleeve than would be necessary anyway for the respective anchor rod being used. At the same time, this wall thickness is sufficient to be able to absorb, without difficulty, the tensile stresses of the ring occurring in the sleeve, which is closed in the circumferential direction.

This is especially the case for the embodiments in which the sleeve is a metal sleeve, in particular a steel sleeve. Such metal sleeves are easy to manufacture, are available inexpensively and are excellently suited for use in the present anchor module because of their mechanical properties. Furthermore, the metal sleeves in the anchor modules are so small that they do not constitute a risk for the construction machines being used in widening a tunnel or mine shaft.

To further improve the mechanical properties of the anchor module on the whole, the anchor rod is preferably made of a fiber reinforced plastic, in particular a glass fiber reinforced plastic. The anchor rod made of fiber reinforced plastic is much lighter weight in comparison with metal anchor rods and therefore offers advantages in processing. With regard to the ability to absorb anchor tensile forces, anchor rods made of metal and fiber reinforced plastic are quite comparable, whereas plastic anchors have a greatly reduced compressive strength and shear strength. However, this does offer advantages in backstopping the anchoring because, due to their low compressive strength and shear strength, the anchor rods made of plastic can be backstopped and/or destroyed without difficulty, for example, by tunneling machines without causing any damage to the machines themselves.

However, the drill bit or at least its drill section is preferably made of metal, in particular steel. Because of the high mechanical stresses that occur in drilling, drill sections and/or drill bits made of metal offer definite advantages with respect to wear and driving forward in comparison with plastic embodiments. Furthermore, the drill bit is so small that the risk of damage to the construction machines in widening a tunnel or mine shaft that has already been anchored is extremely low.

In one specific embodiment of the anchor module, the connecting section of the anchor rod has at least an essentially smooth, conical or circular cylindrical surface segment after manufacture of the anchor rod, and the connection section of the drill bit has a cutting thread for cutting or tapping a thread into the at least one surface segment after completion of the drill bit, such that after installation of the drill bit in the area of its connecting section, the anchor rod has a cut or tapped thread which cooperates with the cutting thread of the drill bit for transmitting torques and/or tensile forces between the anchor rod and the drill bit.

The cutting thread may be embodied in particular as a sharp thread because such a thread geometry is especially suitable for cutting or tapping threads.

Moreover, the anchor rod is preferably hollow, at least in the area of its connecting section, such that the cutting thread of the drill bit is an outside thread and the cut or tapped thread of the anchor rod is an inside thread.

The connecting section of the drill bit may be a threaded rod, which is screwed into the anchor rod until an axial stop on the drill bit comes in contact with an end face of the anchor rod and is secured by the cutting thread on it. The axial stop on the drill bit is preferably formed by the drill section of the drill bit. After the manufacture of the anchor module, the drill bit is preferably attached to the anchor rod solely by the cooperation of the cutting thread and the cut thread or tapped thread.

The cutting thread may have a constant flank angle α of about 10°≦α≦40°, and in particular embodiments about 20°≦α≦30°. In this angle range a thread can be cut or tapped with very little effort on the one hand, while, on the other hand, an extremely load-bearing threaded connection with respect to the transfer of force and torque can be established.

Alternatively, the cutting thread may have a first flank angle α₁ in the area of its threaded tip radially connected to a flank angle α₂ with α₂>α₁. The flank angle α₁ is preferably in the range of about 10°≦α₁≦30°, in particular embodiments approximately 20°, and is thus excellently suited for thread cutting and/or thread tapping. However, the flank angle α₂ may in the range of about 40°≦α₂≦60°, in particular embodiments approximately 50°, so that this range of the cutting thread can form a stable spacer between the anchor rod and the drill bit.

The anchor rod and the drill bit preferably engage in one another in a form-fitting manner in the area of the first flank angle α₁ and form a cavity in the area of the second flank angle α₂. If the connecting section of the anchor rod is designed to be conical or circular cylindrical over its entire surface, then the cavity has a spiral shape or a helical shape.

In the specific embodiment of the anchor module having a cavity in the area of the second plank angle α₂ the anchor rod preferably has an opening in the area of the cavity for filling the cavity with an adhesive. By filling the cavity, which is helical in shape with adhesive in particular, the connection between the drill bit and the anchor rod is further strengthened, in particular with respect to the transfer of torques.

### BRIEF DESCRIPTION OF SEVERAL VIEWS OF THE DRAWINGS

Additional features and advantages of the invention are derived from the following description of preferred specific embodiments with reference to the drawings, in which

FIG. 1 shows a schematic longitudinal section through an anchor module formed in accordance with an embodiment of the present invention;

FIG. 2 shows a perspective view of a functional part of the inventive anchor module according to an embodiment of the present invention;

FIG. 3 shows an axial top view of the functional part of FIG. 2;

FIG. 4 shows a side view of the functional part of FIG. 2;

FIG. 5 shows a longitudinal section V-V through the functional part of FIG. 4 with two detailed views;

FIG. 6 shows a longitudinal section VI-VI through the functional part of FIG. 5 in a state in which it is screwed onto an anchor rod;

FIG. 7 shows a perspective view of a functional part of an anchor module formed in accordance with an additional embodiment of the present invention;

FIG. 8 shows a longitudinal section through the functional part of FIG. 7 with two detailed views;

FIG. 9 shows a detailed view of the anchor module according to an embodiment of the present invention in the area of a threaded tooth;

FIG. 10 shows a side view of a functional part of an anchor module formed in accordance with an additional embodiment of the present invention; and

FIG. 11 shows a schematic detailed section through the anchor module of FIG. 10 in the connecting area between the anchor rod and the functional part.

### DETAILED DESCRIPTION OF THE INVENTION

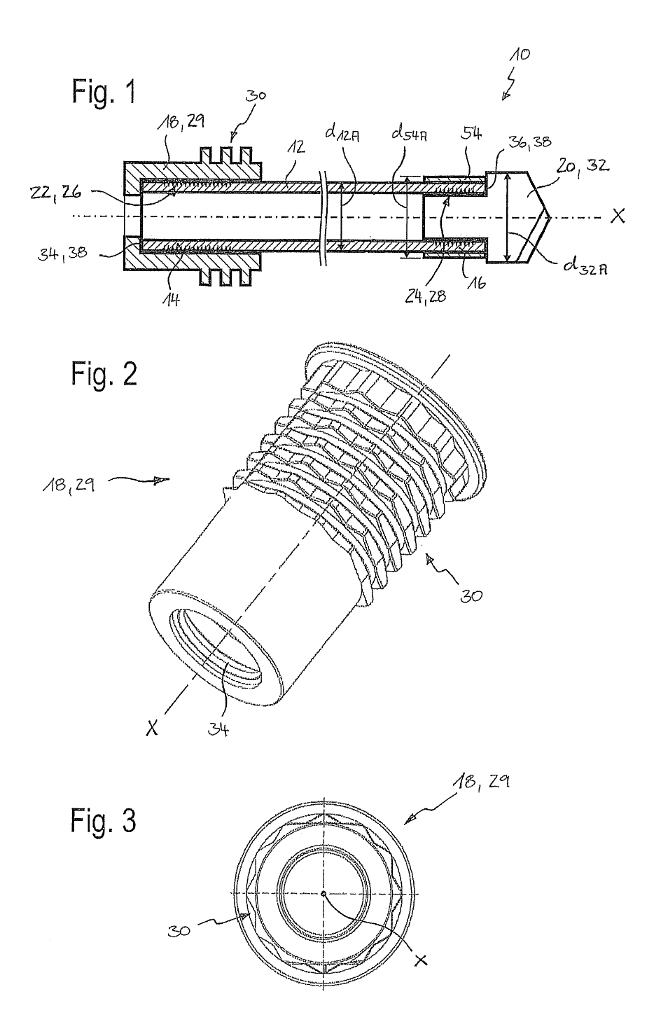

FIG. 1 shows an anchor module 10 formed in accordance with an embodiment of the present invention, particularly well adapted for mining and tunneling, comprising an anchor rod 12 made of plastic which extends along an anchor axis X and which, after fabrication of the anchor rod, has a connecting section 14, 16 in the area of each of its two axial rod ends as well as two functional parts 18, 20, each extending along the anchor axis X and each having a cutting thread 22, 24 for cutting or tapping a thread 26, 28 in the area of the connecting section 14, 16 after fabrication of the functional part.

According to FIG. 1 the anchor rod 12 has a cut thread or tapped thread 26, 28 which cooperates with the cutting thread 22, 24 of the functional parts after installation of the functional parts 18, 20 in the area of the connecting sections 14, 16 for transmitting torques and/or tensile forces between the anchor rod 12 and the functional parts 18, 20.

To be able to cut or tap threads 26, 28 in the area of the connecting sections 14, 16, the anchor rod 12 is designed to be circular cylindrical in the area of the connecting sections 14, 16. In an alternative embodiment the anchor rod 12 is designed to be conical and tapers slightly toward its axial end. In another alternative embodiment, the anchor rod 12 does not have a circular cross section in the area of its connecting sections 14, 16 but instead has opposing flattened faces, for example. It is sufficient in principle for cutting or tapping the threads 26, 28 and thus for connecting the anchor rod 12 to the functional part 18, 20 if the connecting section 14, 16 has at least one essentially smooth, conical or circular cylindrical surface segment, such that a smooth surface segment is understood to refer in particular to a surface segment, which is originally thread-free in fabrication of the anchor rod.

The anchor rod 12 made of plastic is the core piece of the anchor module 10 and, after its final installation, it anchors a tunnel wall or a mine shaft wall, for example, in a substrate or rock surrounding the tunnel or mine shaft. The anchor rod 12 is exposed to enormous tensile stresses in this back-anchoring of the tunnel wall or mine shaft wall. To be able to absorb these tensile stresses without difficulty, the anchor rod 12 according to FIG. 1 is made of fiber reinforced plastic, more specially glass fiber reinforced plastic. An anchor rod 12 made of fiber reinforced plastic offers the advantage that it can absorb high anchor tensile forces without difficulty, whereas its compressive strength and shear strength tend to be low. Because of this low compressive strength and shear strength, the anchor rod 12 and thus ultimately the entire anchor module 10 can be destroyed relatively easily in enlargement of the tunnel cross section or mine shaft cross section without damage to the construction machines used to widen the tunnel and/or mine shaft. In comparison with anchor rods 12 made of steel, the anchor rod 12 made of plastic, in particular fiber reinforced plastic, also offers advantages with regard to the cost of materials and weight.

Apart from the anchor rod 12 made of plastic, the anchor module 10 according to FIG. 1 also comprises the functional part 18, which is designed as a drive element 29 with a drive geometry 30 for applying a torque to the anchor module 10, as well as the functional part 20 designed as a drill bit 32. The anchor module 10 is thus a self-tapping anchor module 10.

In concrete terms, the drive element 29 is a sleeve-shaped nut, which is screwed onto the anchor rod 12 up to its axial stop 34 and is attached to it by the cutting thread 22. However, the connecting section of the drill bit 32 is a threaded rod, which is screwed into the anchor rod 12 until an axial stop 36 of the drill bit 32 comes in contact with an end face 38 of the anchor rod 12 and is secured to it by the cutting thread 24.

Accordingly, the cutting thread 22 may be an inside thread and the cut thread or tapped thread 26 may be an outside thread, as is shown as an example in the connection between the drive element 29 and the anchor rod 12; or the cutting thread 24 is an outside thread and the cut thread or tap thread 28 is an inside thread as is shown, for example, for the connection between the drill bit 32 and the anchor rod 12.

FIGS. 2 and 3 show a perspective detailed view and/or an axial top view of a first specific embodiment of the functional part 18 embodied as a drive element 29. The drive geometry 30 for applying a torque to the anchor module 10 can be seen well here. The drive geometry 30 of the drive element 29 is complementary to the drive geometry of a tool (not shown), for example, a screw attachment of the drilling machine, so that the tool can drive the anchor rod 12 via the drive element 29 and ultimately can drive the drill bit 32 in the circumferential direction via the anchor rod 12. Consequently, the drive geometry 30 should be embodied in such a way that it can transfer the torque applied by the tool to the anchor module 10 with as little slippage as possible. Otherwise the drive geometry 30 is freely selectable.

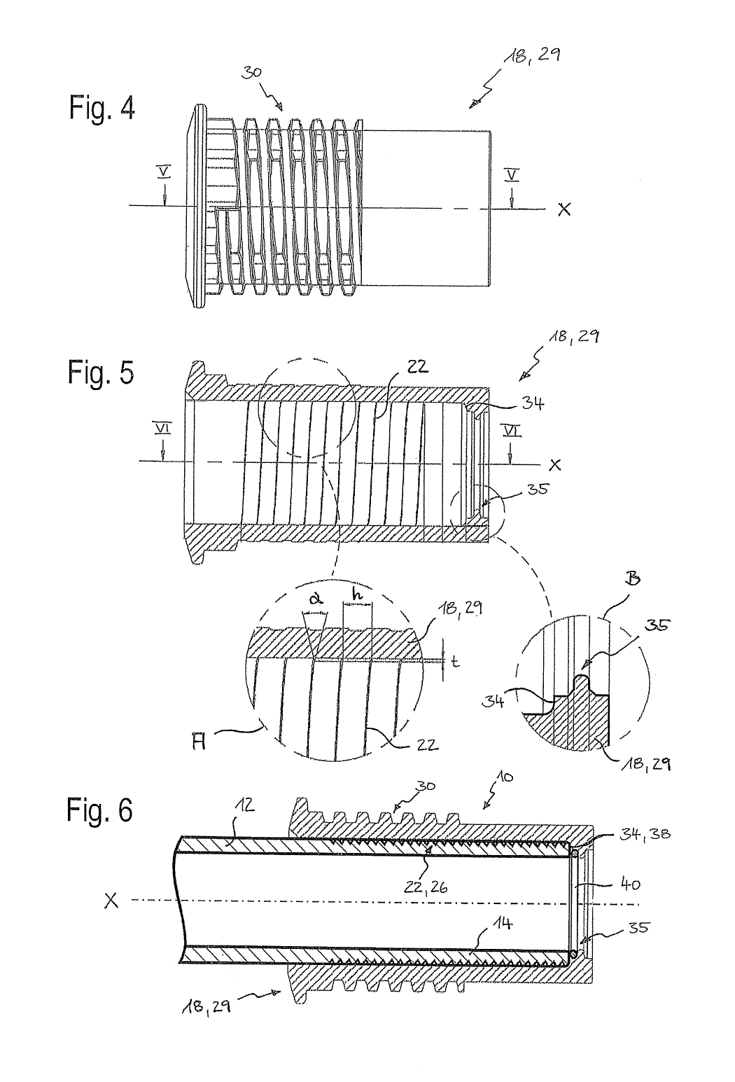

FIG. 4 shows a side view of the functional part 18 according to FIG. 2 and FIG. 5 shows a section taken along line V-V of same.

In the sectional diagram according to FIG. 5 it is clear that the functional part 18, which is embodied as a drive element 29 has the cutting thread 22, which is embodied as an inside thread. This cutting thread 22 is embodied as a sharp thread to be able to cut or tap a thread (an outside thread) in the connecting section 14 of the anchor rod 12 without having to apply a great force. FIGS. 9 and 11 (see detailed view) show examples of the thread geometry of a sharp thread.

In a detail A of a thread in FIG. 5, a thread depth t, a thread pitch h and a flank angle α are shown. The forces and torques that can be transmitted between the functional part 18 and the anchor rod 12 can be defined on the basis of the thread depth t, which is preferably on the order of 0.5 millimeters to 1.5 millimeters, especially preferably approximately 1 millimeters, and the thread pitch h, which is preferably on the order of approximately 5 millimeters.

In the first specific embodiment of the functional part 18 according to FIGS. 2 through 6, the flank angle α of the cutting thread 22 is generally constant and is in the range of about 10°≦α≦40°, especially preferably in the range of about 20°≦α≦30°. At a flank angle α of this order of magnitude it has been found that the thread 26 can be cut and/or tapped well in the plastic anchor rod 12, in particular when the cutting thread 22 is manufactured from a metal, preferably steel.

FIG. 5 comprises an additional detail B, which shows an axial end of the functional part 18 on an enlarged scale. This detail shows clearly the axial stop 34 as well as a sealing contour 35 of the functional part 18, which is to be connected.

FIG. 6 shows a longitudinal section taken along line VI-VI through functional part 18 according to FIG. 5, where the functional part 18 is already screwed onto an axial end, more precisely onto the connecting section 14 of the anchor rod 12. The end face 38 of the anchor rod 12 is in contact with the stop 34 of the functional part 18 here, so that the drive element 29 cannot be screwed further onto the anchor rod 12 in the direction of insertion. In addition, if a torque is applied in the direction of installation, e.g., in creating the borehole for the self-tapping anchor module 10, then the functional part 18 entrains the anchor rod 12 in the direction of rotation.

FIG. 6 also shows a sealing ring 40, which is arranged axially between the functional part 18 and the end face 38 of the anchor rod 12 in the area of the sealing contour 35, in order to seal the space between the functional part 18 and the anchor rod 12.

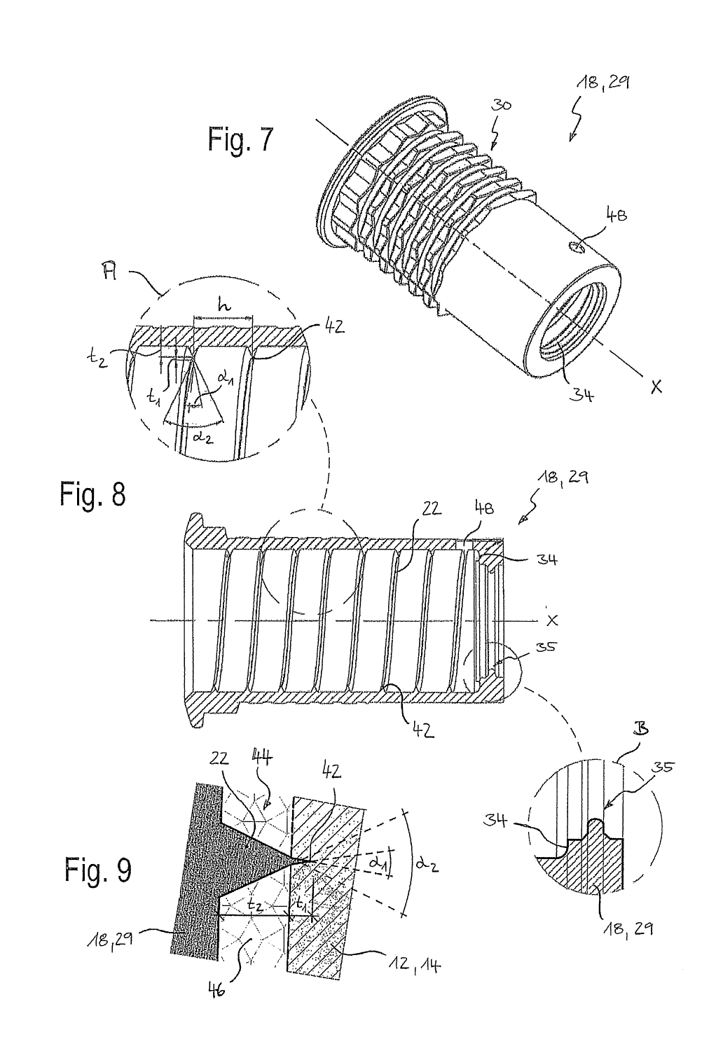

Such a seal is advantageous in particular in a second specific embodiment of the functional part 18, which is shown in FIGS. 7 through 9. Since the second specific embodiment of the functional part 18 is very similar in structure to the first specific embodiment, reference is made explicitly in this regard to the preceding discussion of FIGS. 2 through 6 so that only differences will be discussed in detail below.

FIGS. 7 and 8, like FIGS. 2 and 5, show a perspective view and a longitudinal section, respectively, through the functional part 18 according to the second specific embodiment.

On the basis of thread detail A of FIG. 8 in particular, one will notice that the cutting thread 22, in contrast with the first specific embodiment, has a first flank angle α₁ in the area of its thread tip 42 and, following that radially, a second flank angle α₂, such that α₂>α₁. The flank angles α₁, α₂ are preferably in the range of about 10°≦α₁≦30° and about 40°≦α₂≦60°. In an especially preferred specific embodiment the flank angle α₁≈20° and the flank angle α₂≈50°.

If the functional part 18 is now screwed onto the connecting section 14 of the anchor rod 12, the anchor rod 12 and the functional part 18 engage with one another in a form-fitting manner in the area of the first flank angle α₁ and form a cavity 44 in the area of the second flank angle α₂.

FIG. 9 shows a greatly enlarged detail of this connection in the area of a threaded tooth to illustrate the connection between the anchor rod 12 and the functional part 18 according to the second specific embodiment.

The pitch h of the thread is usually selected to be slightly larger than that in the first specific embodiment of the functional part 18 and is on the order of approx. 10 mm. The thread depth t of the cutting thread 22 in the second specific embodiment of the function part 18 is comprised of a section t₁ having the flank angle α₁ and a section t₂ having a flank angle α₂. Essentially only the thread portion having the flank angle α₁ cuts a thread in the connecting section 14 of the anchor rod 12. The radial section t₁ of the thread depth t is therefore comparable to the thread depth t of the first specific embodiment and is thus also on the order of about 0.5 millimeters to 1.5 millimeters, preferably approximately 0.5 millimeters. The radial section t₂ of the thread depth t of the cutting thread 22 is on the order of 1.5 mm to 2.5 mm and serves essentially as a space holder between the anchor rod 12 and the functional part 18, which is embodied as a threaded nut, so that the anchor rod 12 and the functional part 18 are aligned concentrically after installation.

In certain embodiments in which the connecting section 14 of the anchor rod 12 has a circular cylindrical (or slightly conical) surface on the whole, the cavity 44 has a spiral or helical shape after assembly of the functional part 18 on the anchor rod 12.

In the second specific embodiment of the functional part 18, after screwing the functional part 18 onto the anchor rod 12, this cavity 44 is filled with an adhesive 46, in order to increase the adhesion between the anchor rod 12 and the functional part 18. Thus, even higher forces and torques can be transferred between the anchor rod 12 and the functional part 18 than is the case with a purely threaded connection.

To be able to introduce the adhesive 46 into the cavity 44 after assembly of the functional part 18 on the anchor rod 12, the functional part 18 has an opening 48 in the area of the cavity 44 for filling the cavity 44 with adhesive 46 (cf. FIGS. 7 and 8).

When the adhesive 46 is injected into the cavity 44, the sealing ring 40 (cf. FIG. 6) prevents the adhesive 46 from escaping out of the cavity 44 in the area of the stop 34 on the end face 38 of the anchor rod 12. The opening 48 is close to the stop 34 according to FIGS. 7 and 8 and is thus provided on an axial end of the helical cavity 44. The cavity 44 is filled from right to left, for example, according to FIG. 8, i.e., in a helical pattern in the axial direction when the liquid adhesive 46 is introduced. To facilitate filling with the adhesive 46, another opening, preferably a smaller vent opening is provided at the end of the cavity, which is opposite the opening 48 so that the air volume displaced by the adhesive 46 can escape through this vent opening.

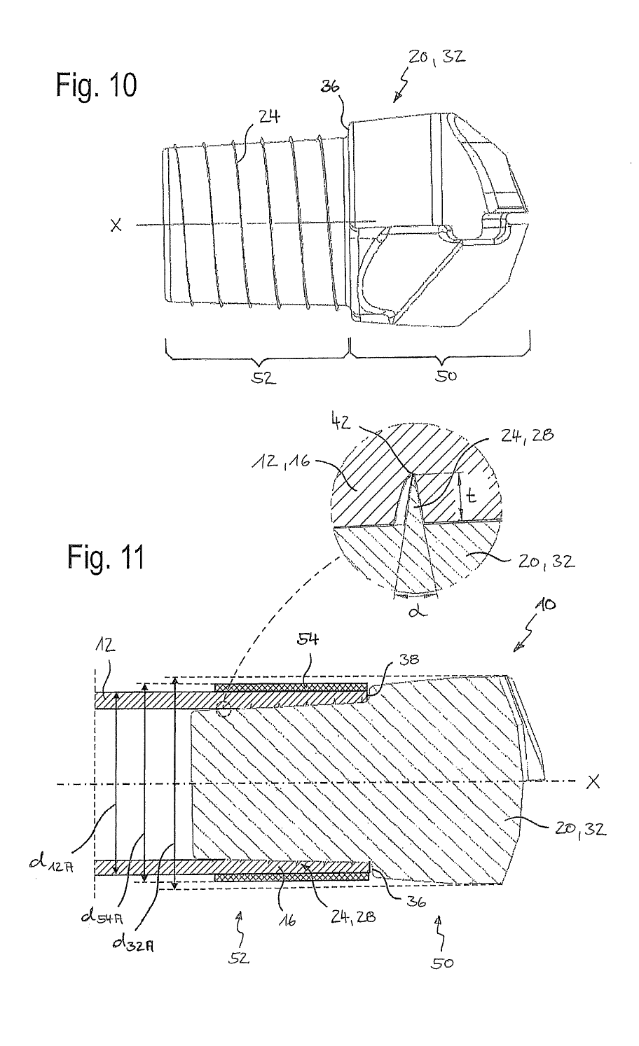

FIG. 10 shows a side view of an embodiment of the functional part 20, which is designed as a drill bit 32. The drill bit 32 comprises a drill section 50 and a connection section 52 for attaching the drill bit 32 to the anchor rod 12, more precisely to the connecting section 16 of the anchor rod 12 (cf. FIGS. 1 and 11).

After fabrication of the drill bit, the connection section 52 of the drill bit 32 has the cutting thread 24 for cutting or tapping the thread 28 in the connecting section 16 of the anchor rod 12, such that after assembly with the drill bit 32, the anchor rod 12 has a thread 28, which is cut or tapped by the cutting thread 24 of the drill bit 32 in the area of its connecting section 16, and cooperates with it to transfer torques and/or tensile forces between the anchor rod 12 and the drill bit 32 (FIGS. 1 and 11). The connecting section 16 of the anchor rod 12 has at least one essentially smooth, i.e., in particular thread-free conical or circular cylindrical surface segment after fabrication of the anchor rod by analogy with the connecting section 14 described above. In the exemplary embodiment according to FIGS. 1 and 11, the entire connecting section 16 of the anchor rod 12 is even designed to be circular cylindrical and/or to taper conically somewhat as shown in FIG. 11.

In contrast with the functional part 18 with the inside thread, the functional part 20 has an outside thread as the cutting thread 24. The anchor rod 12 is hollow at least in the area of its connecting section 16 so that the cutting thread 24 of the drill bit 32, which is embodied as an outside thread itself cuts or taps an inside thread in the connecting section 16 of the anchor rod 12.

FIG. 11 shows a schematic sectional detail of the anchor module 10 in the area of the functional part 20, which is designed as a drill bit 32. A further enlargement in the area of the cutting thread 24 of FIG. 11 shows clearly the cutting thread 24, corresponding essentially to the cutting thread 22 of the functional part 18 in its first specific embodiment according to FIGS. 2 to 6, so that reference is made to the description of the cutting thread 22 according to the first specific embodiment of the functional part 18 with respect to the details about the thread and the parameters of the thread.

Although it is not shown here, the cutting thread 24 may of course also be designed according to the cutting thread 22 of the functional part 18 in its second specific embodiment. However, since the cutting thread 24 is an outside thread, an opening must be formed for filling the corresponding cavity in the area of the cut thread or tapped thread 28 of the anchor rod 12.

If as shown in FIG. 11, a separate sleeve 54 is also provided, surrounding the anchor rod 12 in the area of its connecting section 16, the opening for filling the cavity with adhesive would optionally also have to be provided in the sleeve 54.

FIG. 11 shows the anchor module 10 in particular for mining and tunneling, comprising the drill bit 32 with its drill section 50 and its connecting section 52 as well as the anchor rod 12 made of plastic, which extends along the anchor axis X and includes the connecting section 16 for fastening the drill bit 32 in the area of an axial rod end.

According to FIG. 11, an outside diameter d_{32A} of the drill bit 32 is at most about 20% and, in particular embodiments at most about 10%, and/or at most about 10 millimeters larger than outside diameter d_{12A} of the anchor rod 12 on the connecting section 16. The difference in outside diameter d_{32A} and d_{12A} of the drill bit 32 and the anchor rod 12 (in the area of its connecting section 16) may be at most about 8 millimeters and, in particular embodiments at most about 6 millimeters. Because of this small difference, when the anchor is set the result is a borehole having only a slightly larger diameter than that of the anchor rod 12. The drilling thus proceeds more rapidly, while saving more energy and causing less component stress on the anchor module 10 due to the small drill diameter. Another advantage of this small diameter difference is the lower need for filling material with which the annular space formed between the anchor rod 12 and the substrate surrounding the anchor rod 12 in drilling must be filled.

The separate sleeve 54 surrounds the anchor rod 12 in the area of its connecting section 16 according to FIG. 11, where the outside diameter d_{32A} of the drill bit 32 is larger than the outside diameter d_{54A} of the sleeve 54. The difference in the outside diameters d_{32A} and d_{54A} of drill bit 32 and sleeve 54 is preferably at most about 6 millimeters, especially preferably at most about 3 millimeters.

The sleeve 54 of the illustrated embodiment itself has a maximum wall thickness of about 2 millimeters, in particular embodiments a maximum of about 1 millimeter. It is permanently attached to the anchor rod 12 with a press fit which thus secures its position axially. Due to the press fit and the design of the sleeve 54 as a closed ring, the sleeve 54 prevents radial widening or even axial breaking of the anchor rod 12 when screwing in the drill bit 32. The sleeve 54 thus contributes toward strengthening the connection between the drill bit 32 and the anchor rod 12 with respect to the forces and torques to be absorbed.

To be able to absorb the ring stresses occurring in the sleeve 54 without difficulty, the sleeve 54 may be designed as a metal sleeve, in particular as a steel sleeve.

With respect to the drill bit 32, at least the drill section 50, but preferably the entire drill bit 32 including the cutting thread 24 may be made of metal, in particular steel.

According to FIG. 11, the connecting section 52 of the drill bit 32 is a threaded rod, which is screwed into the hollow anchor rod 12 until an axial stop 36 of the drill bit 32 comes in contact with the end face 38 of the anchor rod 12, and the threaded rod is attached by the cutting thread 24. The axial stop 36 on the drill bit 32 is preferably formed by the radial offset, which is present anyway between the connecting section 52 and the drill section 50. The drill bit 32 is preferably attached to the anchor rod 12 exclusively by the cutting thread 24 and the thread 28. To strengthen this connection between the drill bit 32 and the anchor rod 12, the sleeve 54 may optionally also be provided. Alternatively or additionally, the connection between the drill bit 32 and the anchor rod 12 may also be strengthened by the fact that the cutting thread 24 of the drill bit 32 is designed according to the cutting thread 22 in the second specific embodiment of the functional part 18 according to FIGS. 7 through 9, and the resulting cavity 44 is filled with adhesive 46.

Consequently, the anchor module 10 according to FIG. 1 has connections between the anchor rod 12 and the functional parts 18, 20, where these connections are able to absorb great forces and torques so that the anchor module 10 is excellent for use as a self-tapping anchor module 10. In addition, the anchor module 10 can be manufactured easily and with minimal rejects by following the method described below.

In the first process step, the anchor rod 12 has at least one connecting section 14, 16 in the area of at least one axial rod end, the connecting section having at least one surface segment, which is essentially smooth, conical or circular.

Then the functional part 18, 20 with the cutting thread 22, 24 is manufactured, such that the functional part 18, 20 may be designed, for example, as a drive element 29 or as a drill bit 32 and the cutting thread 22, 24 may be embodied as an inside thread or as an outside thread.

Finally in another process step the functional part 18, 20 is screwed onto the anchor rod 12, such that the cutting thread 22, 24 of the functional part 18, 20 cuts or taps a thread into the at least one conical or circular cylindrical surface segment of the anchor rod 12, forming a cut thread or tapped thread 26, 28, for the transfer of torques and/or tensile forces between the anchor rod 12 and the functional part 18, 20.

The functional part 18, 20 is preferably screwed onto the anchor rod 12 in the direction of installation preferably as far as an axial stop 34, 36. If a torque is then additionally applied to the functional part 18, 20 in the installation direction, the result is a transfer of torque to the anchor rod 12 and/or a reliable entrainment of torque by the anchor rod 12 and vice-versa.

With a suitable geometry of the anchor rod 12 and the functional parts 18, 20, a helical or spiral cavity 44 is formed between the anchor rod 12 and the functional part 18, 20 when the functional part 18, 20 is screwed onto the anchor rod 12, and then this cavity is filled with the adhesive 46 in a subsequent step of the process of manufacturing the anchor module 10.

In a special variant of the embodiment, a separate sleeve 54 surrounding the anchor rod in the area of its connecting section 14, 16 may be applied to the anchor rod 12 even before screwing on the functional part 18, 20 to the anchor rod 12 in order to strengthen the threaded connection between the functional part 18, 20 and the anchor rod 12, which is formed when the former is screwed onto the latter.

In summary, the advantages of the anchor module 10 according to FIG. 1 thus include the simple process of manufacturing the anchor module 10, the minimal borehole size of the self-tapping anchor module 10, and/or the robust screw connections within the anchor module 10, which are capable of absorbing and/or transferring high forces and torques.

1. An anchor module for mining and tunneling comprising:
a drill bit having a drill section and a connecting section; and
an anchor rod made of plastic and extending along an anchor axis, the anchor rod comprising, in the area of an axial rod end, a connecting section for attaching the drill bit, such that the outside diameter of the drill bit is larger than the outside diameter of the anchor rod on the connecting section of the anchor rod,
wherein the outside diameter of the drill bit is at most about 20% and/or at most about 10 millimeters larger than the outside diameter of the connecting section of the anchor rod.

2. An anchor module according to claim 1, wherein the outside diameter of the drill bit is at most about 10% larger than the outside diameter of the connecting section of the anchor rod.

3. An anchor module according to claim 1, wherein the anchor module includes a sleeve, the sleeve surrounding the anchor rod in the area of its connecting section, wherein the outside diameter of the drill bit is larger than the outside diameter of the sleeve.

4. An anchor module according to claim 3, wherein the sleeve 54 is attached to the anchor rod with a press fit.

5. An anchor module according to claim 3, wherein the sleeve has a maximum wall thickness of about 2 millimeters.

6. An anchor module according to claim 3, wherein the sleeve has a maximum wall thickness of about 1 millimeter.

7. An anchor module according to claim 3, wherein the sleeve is a metal sleeve.

8. An anchor module according to claim 1, wherein the anchor rod is made of a glass fiber reinforced plastic.

9. An anchor module according to claim 1, wherein the drill section of the drill bit is made of metal.

10. An anchor module according to claim 1, wherein the connecting section of the anchor rod has at least one generally smooth conical or circular cylindrical surface segment after production of the anchor rod, and the connecting section of the drill bit has a cutting thread for cutting or tapping a thread into the at least one surface segment, such that after assembly with the drill bit in the area of the connecting section of the anchor rod, the anchor rod has a cut or tapped thread which cooperates with the cutting thread of the drill bit for transmitting torques and/or tensile forces between the anchor rod and the drill bit.

11. An anchor module according to claim 10, wherein the cutting thread is designed as a sharp thread.

12. An anchor module according to claim 10, wherein the anchor rod is hollow at least in the area of the connecting section of the anchor rod, such that the cutting thread of the drill bit is an outside thread and the cut or tapped thread of the anchor rod is an inside thread.

13. An anchor module according to claim 12, wherein the connecting section of the drill bit is a threaded rod, which is screwed into the anchor rod until an axial stop of the drill bit comes in contact with an end face of the anchor rod, and is attached to the anchor rod by the cutting thread.

14. An anchor module according to claim 10, wherein the cutting thread has a generally constant flank angle α of about 10°≦α≦40°.

15. An anchor module according to claim 10, wherein the cutting thread has a generally constant flank angle α of about 20°≦α≦30°.

16. An anchor module according to claim 10, wherein the cutting thread has a first flank angle α₁ in the area of a threaded tip and a second flank angle α₂ connected radially thereto, wherein α₂>α₁.

17. An anchor module according to claim 16, wherein the anchor rod and the drill bit engage in one another in a form-fitting manner in the area of the first flank angle α₁ and form a cavity in the range of the second flank angle α₂.

18. The anchor module according to claim 17, wherein the anchor rod has an opening in the area of the cavity for filling the cavity with an adhesive.
